(19) United States
(12) Patent Application Publication
(10) Pub. No.: US 2007/0136220 A1
(43) Pub. Date: Jun. 14, 2007

(54) Apparatus for learning classification model and method and program thereof

(76) Inventor: Shigeaki Sakurai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/525,168

(22) Filed: Sep. 22, 2006

(30) Foreign Application Priority Data
Dec. 8, 2005 (JP) 2005-354939

(51) Int. Cl. G06F 15/18

(52) U.S. Cl. 706/20

(57) ABSTRACT

A classification model learning apparatus for learning a classification model for extracting a particular event from a text includes an evaluation unit for evaluating the existence or nonexistence of the particular event for a plurality of learning texts having both a text and information on the existence or nonexistence of the particular event by applying an event related expression for evaluating the existence or nonexistence of the particular event to each learning text of the plurality of learning texts, an extracting unit for extracting a learning text in accordance with the existence or nonexistence of the particular event evaluated by the evaluation unit, and a learning unit for learning a classification model based on the learning text extracted by the extracting unit.

### CROSS-REFERENCE TO RELATED APPLICATIONS

This application is based upon and claims the benefit of priority from prior Japanese Patent Application No. 2005-354939, filed Dec. 8, 2005, the entire contents of which are incorporated herein by reference.

### BACKGROUND OF THE INVENTION

1. Field of the Invention

The present invention relates to a technique for learning a classification model to evaluate whether or not an event indicating a specific content is written in a text data accumulated in a computer.

2. Description of the Related Art

As a technique to collect and screen training examples, a technique described in “Addressing the Curse of Imbalanced Training Sets: One-Sided Selection”, Proc. of 14^{th} International Conference on Machine Learning, 179-186, 1997, Miroslav Kubat and Stan Matwin is known. The present technique makes use of the training examples including an event as-is. Meanwhile, the present technique performs screening of the training examples by removing similar training examples from a number of training examples not including an event. The present technique selects one of the first training examples randomly from the training examples which do not include an event and makes an evaluation on whether or not it should be left as a training example. For this reason, as a result of depending on the first selected training example, a difference occurs in the training examples to be eventually removed. Accordingly, it is not always possible to leave a training example which does not include a suitable event. In addition, in order to evaluate similarities between the training examples, the distance between each training example needs to be measured. For this reason, when there are a large number of attributes comprising the training example or when there are a large number of training examples, a great deal of time is required to evaluate whether or not the training example which does not include an event should be left.

Alternatively, JP-A 2002-222083 (KOKAI) discloses a technique to deduce a classification class which corresponds to an evaluation example by generating an inference rule from within a group of training examples. At this time, by referring to the user on whether the inference result of the evaluation example is correct or not, the training example is collected. In the present technique, it is likely that a well-balanced training example can be collected for each classification class by providing the inference rule with an evaluation example which is to be the basis for generating the training example. However, as there is no special designation on how to select the evaluation example, it is not always possible to generate a suitable training example. In addition, since the training examples should be generated through interactions with users, the burden on users is extremely high.

Regarding the issue of deducing whether or not a particular event is described by assessing a text, a learning text important for distinguishing an event is screened from learning texts comprised of a collected text and a classification class indicating whether or not an event is written thereto. By making use of this screened learning text, may it be an event which occurs rarely, a classification model for distinction is learned with high accuracy. By using the learned classification model, when a new text is provided, a classification class for the text is deduced.

When the classification model which assesses whether or not a particular event is included in a text is subject to machine learning, it is necessary to compose a training example by collecting texts including an event and texts not including an event in balanced manner. However, when texts are merely collected, the number of texts not including an event tends to outnumber the texts including an event. Thus, an imbalanced training example dominated by texts not including an event is generated. From such imbalanced training example, there is a high possibility of learning a disproportionate classification model which tends to overly distinguish that an event is not included. For this reason, it is required to screen a suitable training example from the generated training examples and learn a classification model which, with high accuracy, distinguishes whether or not an event is included.

### BRIEF SUMMARY OF THE INVENTION

The classification model learning apparatus for learning a classification model for extracting a particular event from a text desired to be assessed the existence or nonexistence of the particular event based on a plurality of learning texts each possessing both a text and information on the existence or nonexistence of the particular event, according to an aspect of the present invention is characterized by comprising: an evaluation unit configured to evaluate the existence or nonexistence of the particular event for a plurality of learning texts having both a text and information on the existence or nonexistence of the particular event by applying an event related expression for evaluating the existence or nonexistence of the particular event to each learning text of the plurality of learning texts; an extracting unit configured to extract a learning text in accordance with the existence or nonexistence of the particular event evaluated by the evaluation unit; and a learning unit configured to learn a classification model based on the learning text extracted by the extracting unit. Further, the present invention is not limited to an apparatus and may include the invention of a method and program realized thereby.

### BRIEF DESCRIPTION OF THE SEVERAL VIEWS OF THE DRAWING

FIG. 1 is a diagram showing a configuration example of a classification model learning apparatus according to an embodiment.

FIG. 2 is a flow chart showing a process of the classification model learning apparatus according to the present embodiment.

FIG. 3 is a diagram showing an example of an event related expression stored in an event related expression storing unit 20.

FIG. 4 is a diagram showing an example of a learning text, which includes dissatisfaction, stored in a learning text storing unit 10.

FIG. 5 is a diagram showing an example of a learning text, which does not include dissatisfaction, stored in the learning text storing unit 10.

FIG. 6 is a diagram showing an example of a learning text, which does not include dissatisfaction, extracted by a learning text extracting unit 40.

FIG. 7 is a diagram showing an example of a training example used by a classification model learning unit 50 to learn a classified model.

FIG. 8A is a diagram showing an example of a classification model related to an attribute “complaint”, which is learnt by the classification model learning apparatus according to an embodiment.

FIG. 8B is a diagram showing an example of a classification model related to an attribute “complaint”, which is learnt by the classification model learning apparatus according to an embodiment.

FIGS. 9A and 9B are diagrams showing an example of a classification model related to an attribute “problem”, which is learnt by the classification model learning apparatus according to an embodiment.

FIG. 10 is a diagram showing an example of an evaluation text stored in an evaluation text storing unit 70.

FIG. 11 is a diagram showing an example of an evaluation example generated from an evaluation text.

FIG. 12 is a diagram showing an example of a classification class deduced for an evaluation text.

### DETAILED DESCRIPTION OF THE INVENTION

Embodiments of the present invention will be explained in reference to the drawings.

Hereinafter, a technique for conveniently performing text analysis, which automatically evaluates whether or not the event is written in a new text, by using an acquired classification model is disclosed. Here, the term “text data” refers to, for example, a posting written on the message board of a web site, a daily report in a retailing sector containing a written business report and e-mails received at customer centers at companies.

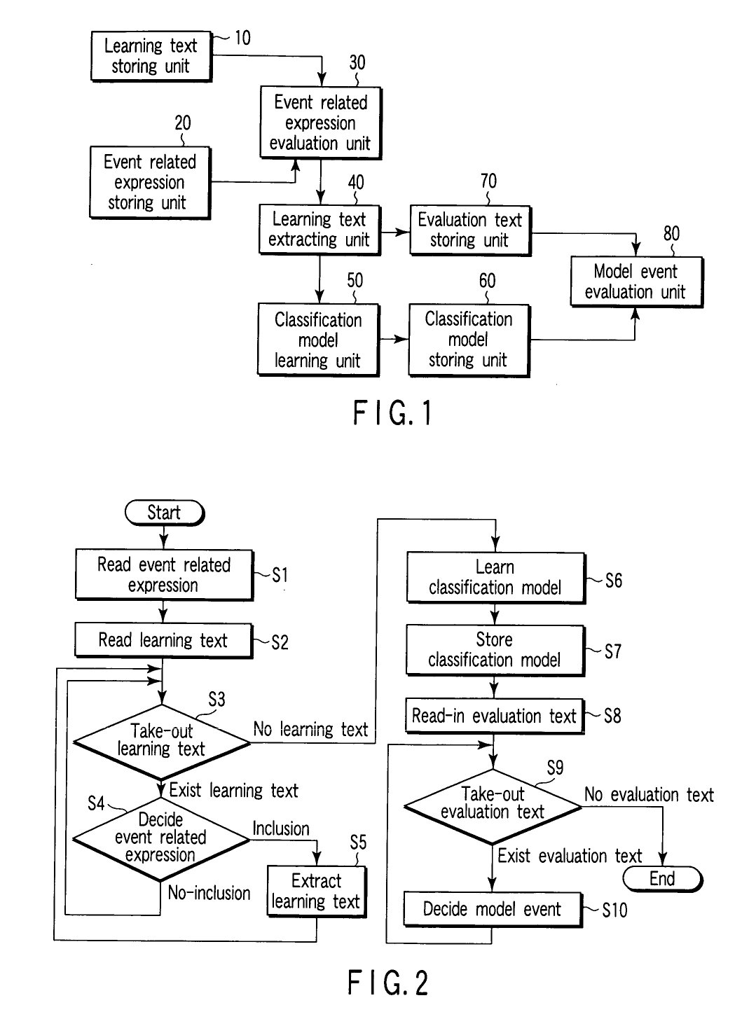

The classification model learning apparatus shown in FIG. 1 includes a plurality of learning texts which respectively contains a text and information on whether or not a particular event exists, learns a classification model by using a group of learning texts devoted for learning a classification model for extracting the particular event, and evaluates the existence or nonexistence of an event for a new text by using a classification model done with learning. The classification model learning apparatus has a learning text storing unit 10, an event related expression storing unit 20, an event related expression evaluation unit 30, a learning text extracting unit 40, a classification model learning unit 50, a classification model storing unit 60, an evaluation text storing unit 70 and a model event evaluation unit 80.

The learning text storing unit 10 stores a group of learning texts, which is a set of a text and existence or nonexistence of a particular event. The event related expression storing unit 20 stores a group of expressions related to an event. The event related expression evaluation unit 30 evaluates the existence or nonexistence of a particular event in each text by applying a group of expressions stored in the event related expression storing unit 20 to each text included in a group of learning texts. The learning text extracting unit 40 extracts a part of a group of learning texts from a group of learning texts based on the existence or nonexistence of a particular event which is a pair with the evaluation result of a text provided by the event related expression evaluation unit 30. The classification model learning unit 50 learns a classification model based on a subset of the learning texts extracted by the learning text extraction unit. The classification model storing unit 60 stores the classification model learnt by the classification model learning unit 50. The evaluation text storing unit 70 stores a text desired to be evaluated the existence or nonexistence of an event. The model event evaluation unit 80 applies the text stored in the evaluation text storing unit 70 to the classification model stored in the classification model storing unit 60 in order to evaluate the existence or nonexistence of an event.

In the above configuration, the classification model learning apparatus according to the embodiment can be realized by, such as, a general-purpose computer (for instance, a personal computer), and the event related expression evaluation unit 30, the learning text extraction unit 40, the classification model learning unit 50 and the model event evaluation unit 80 can each be configured by a program (such as a program module) which realizes the above functions. Alternatively, the classification model learning apparatus may also be configured by hardware (such as a chip) to realize the above function, or may be realized by connecting each unit by a network. Further, in the case of a general-purpose computer, the learning text storing unit 10, the event related expression storing unit 20, the classification model storing unit 60 and the evaluation text storing unit 70 may, for instance, be an external memory unit such as a magnetic-storage device or an optical-storage device, or may also be a server connected via a communication line.

The operation of the classification model learning apparatus configured as above will be explained in reference to FIG. 2. By following the process described in the flowchart of FIG. 2, the classification model learning apparatus learns a classification model which evaluates from a group of learning texts attached a description or no description of an event whether or not a particular event is included in a text. Further, according to the classification model learning apparatus related to the embodiment, when a new text is provided, whether or not an event is described can be deduced in accordance with the learnt classification model.

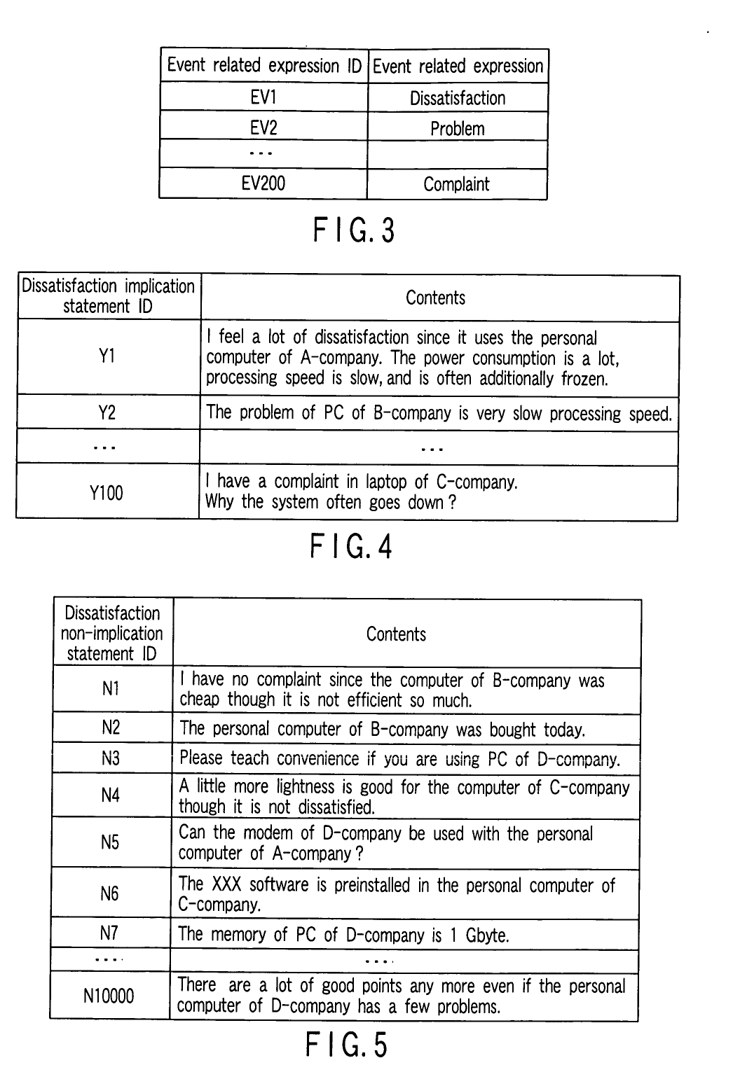

First, the event related expression evaluation unit 30 reads in an event related expression (word) from the event related expression storing unit 20 (step S1). Here, the “event related expression” denotes a keyword or key phrase which is used when evaluating whether or not a particular event exists in a text. For example, when evaluating whether or not a text includes an event such as “unsatisfied”, a keyword shown in FIG. 3 is stored in the event related expression storing unit 20 as an event related expression. FIG. 3 is an example of event related expressions stored in the event related expression storing unit 20. The event related expression ID and the event related expression are registered in pairs. For instance, an event related expression ID “EV1” and an event related expression “unsatisfied”, and an event related expression ID “EV2” and an event related expression “problem” are registered respectively in pairs.

Next, the event related expression evaluation unit 30 reads in a learning text given description or no description of an event from the learning text storing unit 10 (step S2). Whether or not to describe an event on a learning text is usually evaluated by a user who has read the learning text. A learning text given description or no description of an event is thus generated. At this time, since the number of texts including an event is smaller than the number of texts not including an event, the majority of learning texts are learning texts not including an event. Here, an example of a learning text including an event “unsatisfied” is shown in FIG. 4, and an example of a learning text not including the event “unsatisfied” is shown in FIG. 5.

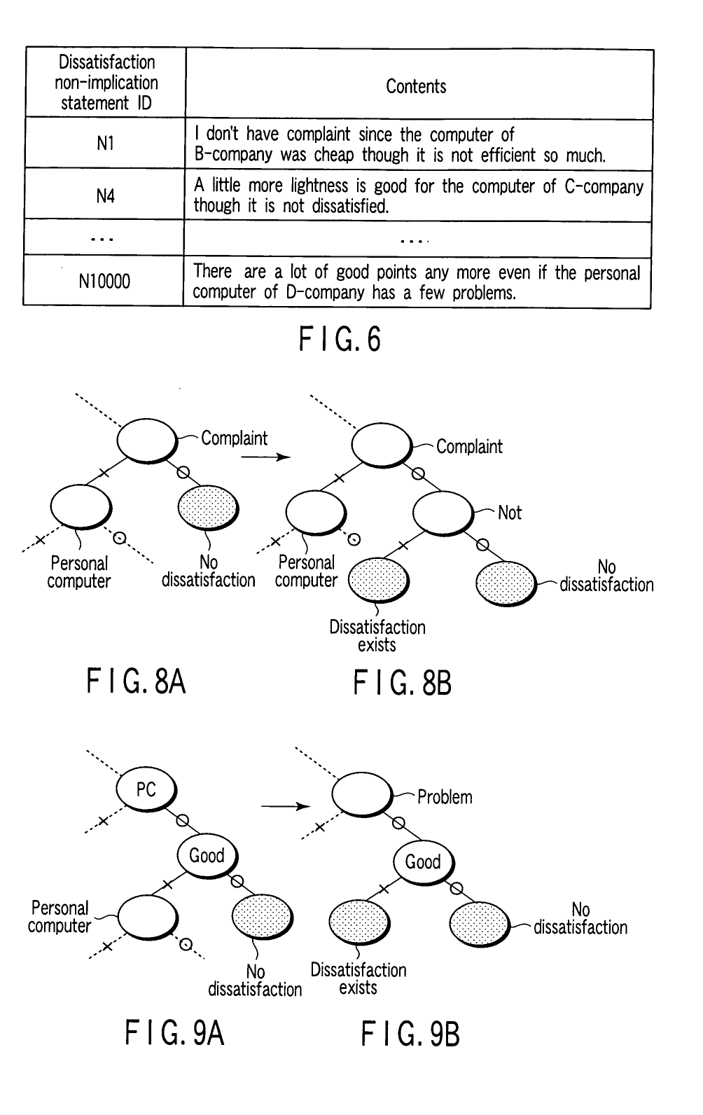

Next, the event related expression evaluation unit 30 takes out one of the learning texts not including an event from the read in learning text (step S3). In step S3, when there is a learning text to take out, the event related expression evaluation unit 30 evaluates whether or not the taken out learning text includes an event related expression with reference to the read in event related expressions (step S4). In this case, for instance, in the example shown in FIG. 5, contents with entirely no dissatisfaction are presented as the learning text. When applying these learning texts to the event related expressions shown in FIG. 3, for example, since N1 includes a keyword “complaint”, it is evaluated as including an event related expression. On the other hand, learning text N2 is evaluated as not including an event related expression. When the event related expression evaluation unit 30 evaluates that an event related expression is included in the learning text in step S4, the learning text extracting unit 40 extracts the learning text evaluated as including an event (step S5). Here, for instance, a group of learning texts shown in FIG. 6 is extracted from a group of learning texts not including an “unsatisfied” event in FIG. 5.

In step S4, when the event related expression evaluation unit 30 evaluates that an event related expression is not included in the learning text, the process goes back to step S3. In step S3, when there is no learning text to take out, the classification model learning unit 50 learns a classification model of a tree structure form from a learning text not including an event and a learning text including an event extracted from the learning text extracting unit 40 by using a text mining method (step S6). Text mining method is, for example, described in “Acquisition of a Knowledge Dictionary Symposium, ISMIS 2002, 103-113, 2002, Shigeaki Sakurai, Yumi Ichimura, and Akihiro Suyama”.

The classification model learning unit 50 learns as follows. The text part of a learning text is decomposed to a group of words by morphological analysis. Evaluation values for keywords and key phrases collected from all learning texts are calculated based on their frequency. A group of keywords and key phrases greater than or equal to the threshold value designated by this evaluation value is regarded as an attribute vector, which characterizes a group of learning texts. By evaluating whether or not a keyword and key phrase corresponding to each attribute of the attribute vector occurs for each learning text, the value of the attribute vector corresponding to the learning text is determined. A training example is generated by pairing up this attribute vector with a classification class which indicates that an event is described or undescribed. The classification model of a tree structure is learnt from a group of this training example.

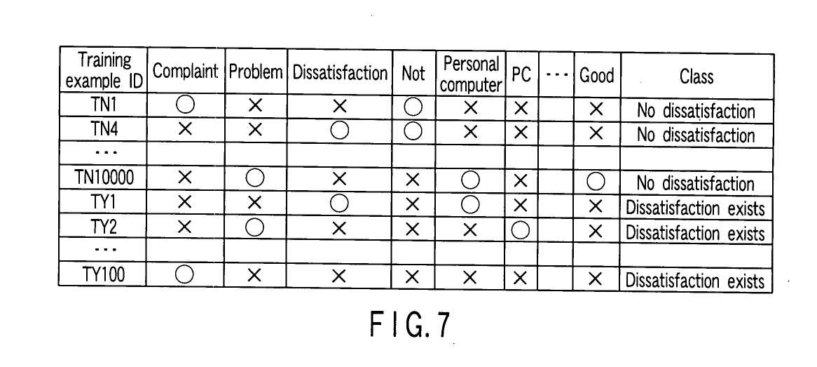

For example, when considering learning a classification model from the learning texts of FIGS. 4 and 6, the evaluation value is calculated by morphological analysis. Herewith, a column of keywords such as, “complaint”, “problem”, . . . , “good”, shown in the first row of FIG. 7 are selected as attributes comprising the attribute vector. Each learning text determines the value of the attribute vector by evaluating the existence or nonexistence of each keyword. Thus, a training example shown in FIG. 7 is generated. Further, in the training example of FIG. 7, “◯” depicts that the keyword exists in the text, and “X” depicts that the keyword does not exist in the text. By inputting this training example, a classification model of a tree structure is learnt.

This way, a learning text not including event related expressions is removed from the learning text which does not include an event. Thus, when using all learning texts, a classification model reflecting a training example prone to be regarded as a noise can be learnt.

Learning examples of the classification model are shown in FIGS. 8 and 9, where the attribute is allocated to a shaded node (a branch node) and the classification class is allocated to a shaded note (an end node). In addition, to each branch subordinate to the branch node is allocated an attribute value showing the existence or nonexistence of a keyword and key phrase corresponding to the attribute of the relevant branch node.

When considering a part of the classification model shown in FIG. 8A, it shows a training example allocating a classification class “not unsatisfied” when a term “complaint” exists. In such case, a training example labeled with a few “unsatisfied” exists in the training example corresponding to this “not unsatisfied”. However, when all learning texts are targeted, in some cases, a training example labeled with “unsatisfied” may be regarded as a noise. However, the rate of training examples corresponding to “unsatisfied” can be increased by extracting only a learning text including event related expressions, learning the classification model and removing the training example corresponding to a redundant “not unsatisfied”. Thus, the training example labeled “unsatisfied” does not become regarded as a noise. Accordingly, as shown in a part of the classification model in FIG. 8B, a classification model broken down into further detail is generated by using a new attribute “not”. In addition, in comparison to the case where all training examples are used for learning a classification model, the rate of keywords related to event related expressions becomes relatively high. Accordingly, a keyword related to the event related expression becomes easy to be selected as an attribute for comprising a classification model. In other words, instead of the classification model shown in FIG. 9A being generated, the classification model shown in FIG. 9B is generated.

The classification model learning unit 50 stores the classification model acquired as above in the classification model storing unit 60 (step S7).

The classification model learning ends with the above steps. Subsequently, by using the acquired classification model, a text is evaluated in steps S8 to S10.

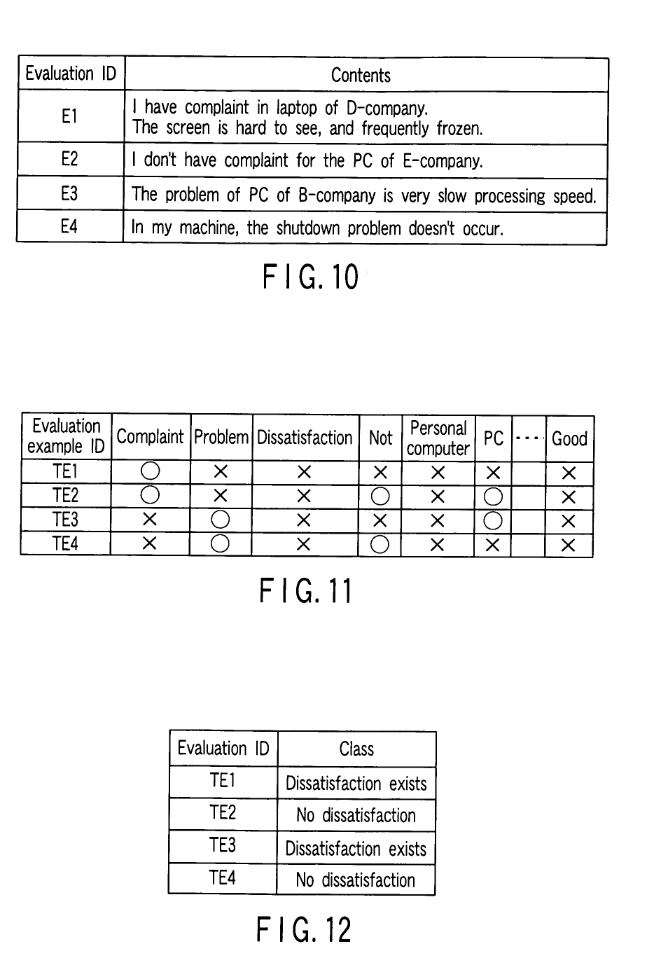

The model event evaluation unit 80 reads in the evaluation text stored in the evaluation text storing unit 70 (step S8). For example, as an evaluation text, a text shown in FIG. 10 is provided. As shown in FIG. 10, the evaluation text is not provided with a classification class indicating whether or not an event is written.

An evaluation text is taken out from the evaluation texts read in by the model event evaluation unit 80 (step S9). At this time, when there is no evaluation text to take out, the process terminates, and when there is an evaluation text to take out, the model event evaluation unit 80 evaluates the model event for the evaluation text (step S10).

More specifically, the model event evaluation unit 80 first performs morphological analysis on the taken out evaluation text and evaluates whether or not it includes the keywords corresponding to each attribute of the attribute vector determined by the classification model learning unit 50. Based on the evaluation result, the model event evaluation unit 80 generates, for instance, an evaluation example as shown in FIG. 11 for the evaluation text shown in FIG. 10. By applying this evaluation example to a classification model done with learning, the model event evaluation unit 80 evaluates whether or not to attach an event to the evaluation text and outputs a classification class as shown in FIG. 12 as a classification class for an evaluation text. Thus, by applying the evaluation example as shown in FIG. 11 to the classification model, a classification class shown in FIG. 12 may be deduced for each evaluation text.

Thus, by learning the classification model from the selected learning text, the classification class corresponding to the evaluation text can be deduced with high accuracy.

The classification model learning apparatus related to the present embodiment is not restricted to the above embodiments. For instance, the keyword or key phrase stored in the event related expressions storing unit 20 can be given with attaching the category information. At the same time, decomposition of a word attached with category information is performed in a morphological analysis performed on the text.

Alternatively, as a keyword and key phrase comprising the attribute vector selected at the classification model learning unit 50, in addition to the evaluation value calculated based on the frequency, it is also fine to have only the keywords and key phrases with a certain alignment in category selected.

Additionally, a text mining method for learning the classification model in a tree structure has been used as the classification model in the classification model learning unit 50, however, by using a text mining method based on SVM (Shigeaki Sakurai, Chong Goh, Ryohei Orihara: “Analysis of Textual Data with Multiple Classes”, Symposium on Mthodologies for Intelligent Systems (ISMIS2005), 112-120, Saratoga, USA, (2005-05)) for instance, a classification model written in hyperplane can be learnt as well.

As mentioned above, by specifying a group of expressions related to the existence of an event and collecting a learning text resembling the related expressions, disproportion of the learning text can be revised. In addition, it is possible to acquire a classification model evaluating a learning text which resembles the expressions and does not include an event and a learning text which resembles the expressions and includes a rare event. Thus, a text including a rare event can be extracted with high accuracy. Further, the evaluation based on the implication of an expression related to the existence of such event is performed only once for each text, therefore, the screening of the learning text can be carried out at high speed. In addition, since the learning text itself can be reduced in numbers, the classification model can be learnt at high speed.

As mentioned above, a suitable training example can be screened from the generated training examples, and a classification model for accurately distinguishing whether or not the event is included can be learnt.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A classification model learning apparatus for learning a classification model for extracting a particular event from a text having both a text and information on the existence or nonexistence of the particular event, comprising:
an evaluation unit configured to evaluate the existence or nonexistence of the particular event for a plurality of learning texts having both a text and information on the existence or nonexistence of the particular event by applying an event related expression for evaluating the existence or nonexistence of the particular event to each learning text of the plurality of learning texts;
an extracting unit configured to extract a learning text in accordance with the existence or nonexistence of the particular event evaluated by the evaluation unit; and
a learning unit configured to learn a classification model based on the learning text extracted by the extracting unit.

2. The apparatus according to claim 1, further comprising a storing unit for storing the classification model learnt by the learning unit.

3. The apparatus according to claim 1, further comprising;
a first storing unit configured to a plurality of learning texts each possessing the text and information of existence or nonexistence of the particular event; and
a second storing unit configured to store event related expressions for extracting a particular event from the learning text;
wherein, the evaluation unit evaluates the existence or nonexistence of a particular event for the learning text by applying event related expressions stored in the second storing unit to each of the plurality of learning texts included in a group of learning texts stored in the first storing unit.

4. The apparatus according to claim 1, further comprising a second evaluation unit configured to evaluate the existence or nonexistence of an event for the text by applying a text desired to be evaluated the existence or nonexistence of an event to a classification model learnt by the learning unit.

5. The apparatus according to claim 4, further comprising a storing unit configured to store the text desired to be evaluated the existence or nonexistence of an event by the second evaluation unit.

6. The apparatus according to claim 1, wherein the learning unit learns a classification model of a tree structure form from learning texts including an event and those not including an event by using a text mining method.

7. A classification model learning method for learning a classification model to extract a particular event from a text comprises;
evaluating the existence or nonexistence of a particular event for a plurality of learning texts having both a text and information on the existence or nonexistence of the particular event by applying an event related expression for evaluating the existence or nonexistence of the particular event to each of the plurality of learning texts;
extracting a learning text in accordance with the existence or nonexistence of the particular event evaluated by the event related expression evaluation unit; and
learning a classification model based on the extracted learning text.

8. A program for learning a classification model to extract a particular event from a text comprises;
evaluating the existence or nonexistence of a particular event for a plurality of learning texts having both a text and information on the existence or nonexistence of the particular event by applying an event related expression for evaluating the existence or nonexistence of the particular event to each of the learning texts of the plurality of learning texts;
extracting a learning text in accordance with the existence or nonexistence of the particular event evaluated by the event related expression evaluation unit; and
learning a classification model based on the extracted learning text.
